(19) United States
(12) Patent Application Publication
(10) Pub. No.: US 2007/0021079 A1
(43) Pub. Date: Jan. 25, 2007

(54) Wireless electronic device and method for controlling the wireless electronic device

(75) Inventor: Yung-Sen Lin, Taipei Hsien (TW)

Correspondence Address: REED SMITH LLP, Suite 1400, 3110 Fairview Park Drive, Falls Church, VA, 22042, US

(73) Assignee: Acer Incorporated

(21) Appl. No.: 11/443,004

(22) Filed: May 31, 2006

(30) Foreign Application Priority Data
Jul. 19, 2005 (TW) 94124308

(51) Int. Cl. H04B 1/04

(52) U.S. Cl. 455/127.1; 455/127.4

(57) ABSTRACT

A wireless electronic device includes a first antenna having a first gain, a second antenna having a second gain, and a processing circuit for alternatively performing a first mode or a second mode. When the first mode is performed, the processing circuit outputs wireless signals via the first antenna, and receives wireless signals via the first antenna. When the second mode is performed, the processing circuit outputs wireless signals via the first antenna, and receives wireless signals via the second antenna.

### CROSS REFERENCE TO RELATED APPLICATIONS

This application claims the right of priority based on Taiwan Patent Application No. 094124308 entitled “WIRELESS ELECTRONIC DEVICE AND METHOD FOR CONTROLLING THE WIRELESS ELECTRONIC DEVICE”, filed on Jul. 19, 2005, which is incorporated herein by reference and assigned to the assignee herein.

### FIELD OF THE INVENTION

The present invention relates to a wireless electronic device, an antenna module, and a method for controlling the wireless electronic device.

### BACKGROUND OF THE INVENTION

Under wireless LAN standards IEEE 802.11a or 802.11g, the wireless transmission rate has reached 30 Mbps and thus has made possible the wireless transmission of High Definition Digital TV (HDTV) signals. However, the transmission distance limits the transmission rate. If a user wants to watch HDTV on his wireless electronic device, his wireless electronic device must be placed within a limited distance to the HDTV signal source (e.g., an Access Point).

As known, in the wireless communication, the signal would be decayed along the transmission distance. That is, the longer transmission distance is involved, the lower transmission rate is allowed. As follows, three prior-art approaches to enhance the transmission rate with a given transmission distance are discussed.

The first one is to increase the outputting power of the wireless signal source, but it is impractical. In most countries, the outputting power of the wireless device is strictly regulated for healthy concerns. Moreover, high outputting power of one wireless device will interfere the signals from other wireless devices.

The second one is to increase the sensitivity of the processing circuits in the wireless electronic device. However, the manufacturing cost of this approach is too high to be generally adopted.

The third one is to increase the gain of the antenna. However, in the prior-arts, the wireless signal is transmitted or received via the same antenna. When the gain is increased, not only does the capability of signal receiving increase, but also the outputting power arises. Because of the outputting power is strictly regulated as mentioned above, this approach is also impractical.

### SUMMARY OF THE INVENTION

The present invention is to provide a wireless electronic device, an antenna module, and a method for controlling the wireless electronic device.

One aspect of the present invention is to receive wireless signals via antennas having different gains. Another aspect of the present invention is to output wireless signals via a first antenna with a low gain and receive wireless signals via a second antenna with a high gain. Accordingly, the present invention supports the longer transmission distance or the higher transmission rate for receiving wireless signals, while avoids increasing the outputting power of the wireless signal source.

In one embodiment, disclosed is a wireless electronic device including a first antenna having a first gain, a second antenna having a second gain, and a processing circuit for alternatively performing a first mode or a second mode. When the first mode is performed, the processing circuit outputs wireless signals via the first antenna, and receives wireless signals via the first antenna. When the second mode is performed, the processing circuit outputs wireless signals via the first antenna, and receives wireless signals via the second antenna.

In another embodiment, disclosed is an antenna module used in a wireless electronic device for connecting with a wireless network. The wireless electronic device has a first mode and a second mode. The antenna module includes a first antenna having a first gain and a second antenna having a second gain. When the first mode is performed, the first antenna outputs and receives wireless signals for the wireless electronic device. When the second mode is performed, the first antenna outputs wireless signals for the wireless electronic device, and the second antenna receives wireless signals for the wireless electronic device.

Also disclosed is a method for controlling a wireless electronic device. The wireless electronic device has a first mode and a second mode. The method includes: (a) providing a first antenna, the first antenna having a first gain; (b) providing a second antenna, the second antenna having a second gain; (c) selectively performing the first mode or the second mode; (d) when the first mode is performed, outputting wireless signals via the first antenna, and receiving wireless signals via the first antenna; and (e) when the second mode is performed, outputting wireless signals via the first antenna, and receiving wireless signals via the second antenna.

The foregoing and other features of the invention will be apparent from the following more particular description of embodiment of the invention.

### BRIEF DESCRIPTION OF THE DRAWINGS

The present invention is illustrated by way of example and not intended to be limited by the figures of the accompanying drawing, in which like notations indicate similar elements.

FIG. 1a illustrates a wireless electronic device according to an embodiment of the present invention;

FIG. 1b illustrates the first antennas 102a, 102b and the second antenna 104 according to an embodiment of the present invention;

FIG. 2a illustrates a switch circuit according to an embodiment of the present invention;

FIG. 2b illustrates a switch circuit according to another embodiment of the present invention;

FIG. 3 is a flowchart of a method according to an embodiment of the present invention.

### DETAILED DESCRIPTION

The present invention directs to wireless electronic devices, such as PCs, laptop computers, PDAs, mobile phones, portable multimedia devices with the wireless communication functionality, or any other electronic devices having antennas for the wireless communication. The antenna can be a whip-like antenna, a slot antenna, an inverted-F antenna, a notch antenna, or any other antenna known to those skilled in the art. Also, the antenna is not limited to be omni-directional or directional, internal or external, single-band, dual-band, or tri-band antennas. In an embodiment, the antenna invention is configured to operate in the ISM and U-NII bands for WLAN applications. In another embodiment, the antenna is configured to operate under IEEE 802.11a or 802.11b for wireless communications. In still another embodiment, the antenna invention is configured to operate under Bluetooth protocol for wireless communications. However, the devices, elements, steps or operations in the following embodiments are provided for exemplary purposes only. Those skilled in the art should understand that the present invention is applicable to other wireless bands and other wireless electronics devices.

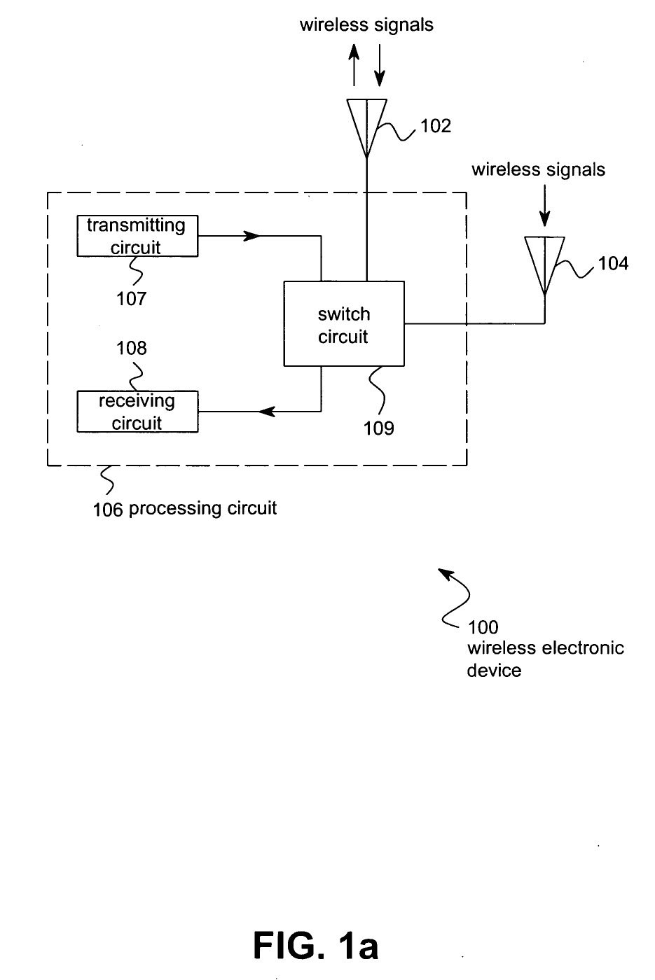

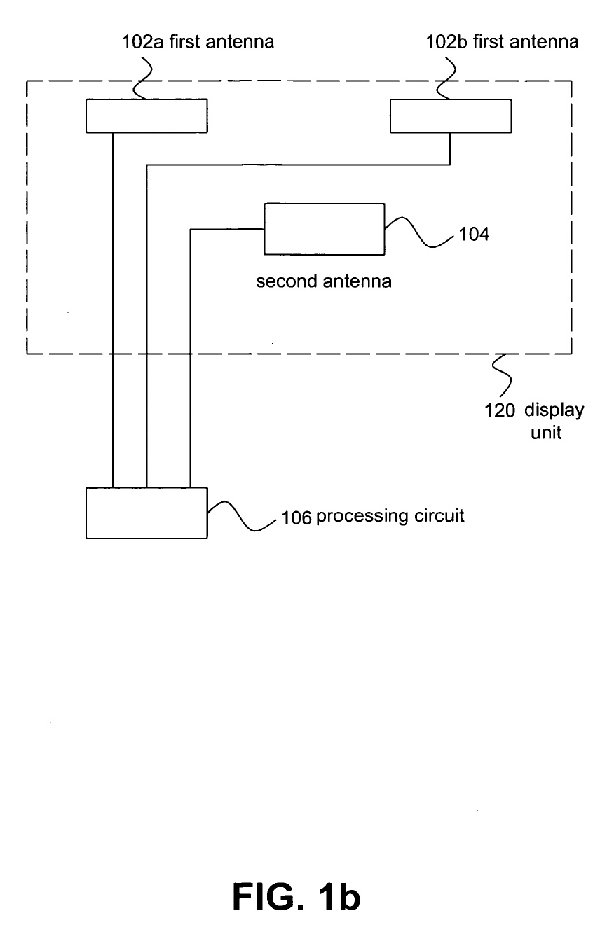

Referring to FIG. 1a, the wireless electronic device 100 includes a first antenna 102, a second antenna 104, and a processing circuit 106. The first antenna 102 has a first gain, and the second antenna 104 has a second gain.

The present invention does not intend to limit the number of the first antenna 102 and the second antenna 104 adopted in the wireless electronic device 100. In one embodiment where the wireless electronic device 100 is implemented as a laptop, two first antennas 102a, 102b, and one second antenna 106 are disposed in the display unit 120 of the wireless electronic device 100, as shown in FIG. 1b. Like the WLAN antennas used in the conventional laptops, the first antennas 102a, 102b are omni-directional and have the gain equal to −3 dBi. The first antennas 102a, 102b are respectively disposed in the different positions on the top of the display unit 120, in order to obtain the better omni-directionality. The second antenna 104 and the first antennas 102a, 102b have the substantially identical working frequency. The second antenna 104 is preferably, but not limited to, a directional antenna and is disposed in the rear middle position of the display unit 120. The second antenna 104 has the gain equal to 2-3 dBi, greater than the gains of the first antennas 102a, 102b. In another embodiment, the first antenna 102 and the second antenna 104 disposed in an external antenna module (not shown), and the external antenna is inserted into the wireless electronic device 100 for transmitting/receiving wireless signals. Note that the gain of the second antenna 104 can be predetermined according to the distance of the wireless electronic device 100 to the wireless signal source or the required data transmission rate.

Again referring to FIG. 1a, the wireless electronic device 100 has a first mode and a second mode, and the processing circuit 106 alternatively performs the first mode or the second mode. When the first mode is performed, the processing circuit 106 outputs wireless signals via the first antenna 102, and receives wireless signals via the first antenna 102. When the second mode is performed, the processing circuit 106 outputs wireless signals via the first antenna 102, and receives wireless signals via the second antenna 104. In another embodiment, when the second mode is performed, the processing circuit outputs wireless signals via the first antenna 102, and receives wireless signals further via the first antenna 102 and the second antenna 104.

The processing circuit 106 includes a transmitting circuit 107, a receiving circuit 108, and a switch circuit 109. The switch 109 is provided for switching between the first mode and the second mode. When the first mode is performed, the switch circuit 109 alternatively connects the transmitting circuit 107 to the first antenna 102 for transmitting the wireless signals, or connects the receiving circuit 108 to the first antenna 102 for receiving the wireless signals. When the second mode is performed, the switch circuit 109 alternatively connects the transmitting circuit 107 to the first antenna 102 for transmitting the wireless signals, or connects the receiving circuit 108 to the second antenna 104 for receiving the wireless signals.

The transmitting circuit 107 includes a transmitter, a filter, an oscillator, a mixer, an amplifier, and other conventional electronic devices for transmitting wireless signals. The receiving circuit 108 includes a receiver, a filter, an oscillator, a mixer, an amplifier, and other conventional electronic devices for receiving wireless signals. In one embodiment, the transmitting circuit 107 and the receiving circuit 108 are embodied as a transmitting circuit and a receiving circuit in a conventional laptop for transmitting and receiving WLAN signal, so the details of the transmitting circuit 107 and the receiving circuit 108 are omitted hereinafter.

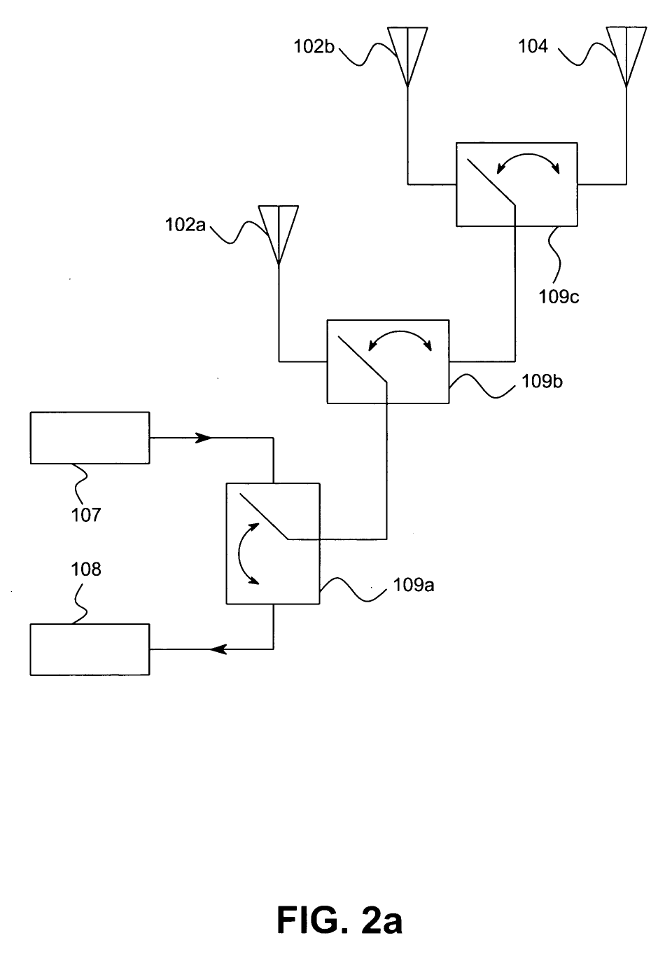

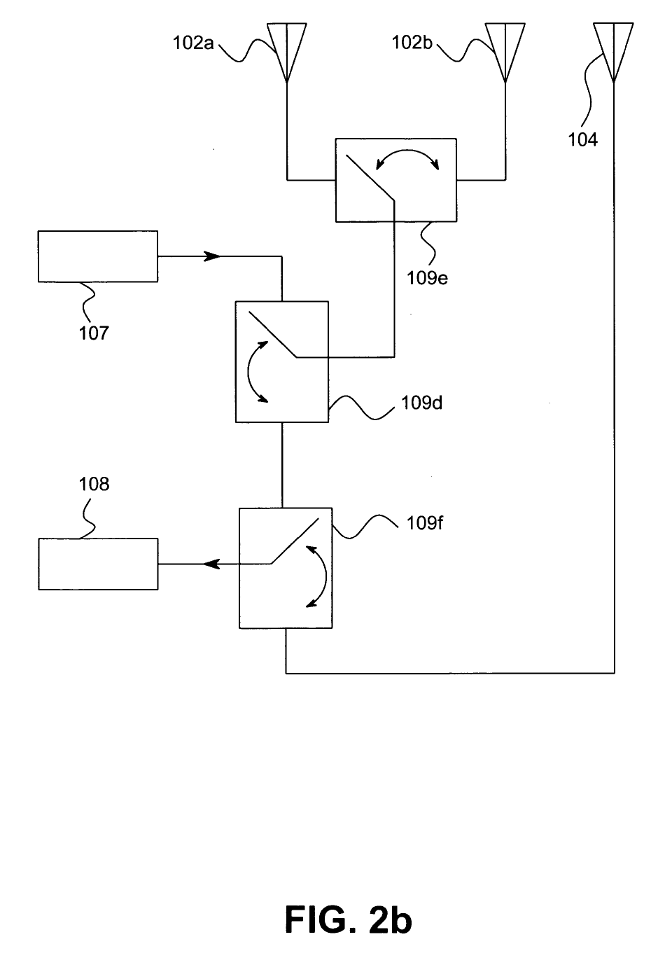

FIG. 2a illustrates the configuration of the switch circuit 109 according to an embodiment of the present invention. The switch circuit 109 includes switches 109a, 109b, and 109c. In the first mode, for transmitting wireless signals, the switch 109a connects the transmitting circuit 107 and the switch 109b, and the switch 109b is further connected to the first antenna 102a; for receiving wireless signals, the switch 109a connects the receiving circuit 108 and the switch 109b, the switch 109b is connected to the switch 109c, and the switch 109c is further connected to the first antenna 102b. Alternatively, in the first mode, while the first antenna 102a is configured to transmit wireless signals, it can also be configured to receive wireless signals; on the other hand, while the first antenna 102b is configured to transmit wireless signals, it can also be configured to receive wireless signals. In the second mode, for transmitting wireless signals, the switch 109a connects the transmitting circuit 107 and the switch 109b, and the switch 109b is further connected to the first antenna 102a for transmitting the wireless signals. Alternatively, the transmitting circuit 107 connects to the first antenna 102b via the switch 109a, 109b, and 109c for transmitting the wireless signals. In the second mode, for receiving wireless signals, the switch 109a connects the receiving circuit 108 and the switch 109b, the switch 109b is connected to the switch 109c, and the switch 109c is further connected to the second antenna 104.

FIG. 2b illustrates the configuration of the switch circuit 109 according to another embodiment of the present invention. The switch circuit 109 includes switches 109d, 109e, and 109f. In the first mode, for transmitting wireless signals, the switch 109d connects the transmitting circuit 107 and the switch 109e, and the switch 109e is alternatively connected to the first antenna 102a or the first antenna 102b to obtain a better transmitting performance; for receiving wireless signals, the switch 109f connects the receiving circuit 108 and the switch 109d, the switch 109d is connected to the switch 109e, and the switch 109c is alternatively connected to the first antenna 102a or the first antenna 102b to obtain a better receiving performance, wherein while the first antenna 102a is configured to transmit wireless signals, it can also be configured to receive wireless signals, and on the other hand, while the first antenna 102b is configured to transmit wireless signals, it can also be configured to receive wireless signals. . In the second mode, for transmitting wireless signals, the switch 109d connects the transmitting circuit 107 and the switch 109e, and the switch 109e is alternatively connected to the first antenna 102a or the first antenna 102b to obtain a better transmitting performance; for receiving wireless signals, the switch 109f connects the receiving circuit 108 and the second antenna 104.

Switches 109a-109f of the switch circuit 109 shown in FIG. 2a and FIG. 2b can be embodied as mechanical switches, electronic switches, or other conventional switches. Preferably, the processing circuit 109 controls the switch circuit according to a predetermined procedure. In an embodiment, when the processing circuit 109 is going to receive HDTV signals or the data transmission rate is up to 30 Mbps, the processing circuit 109 performs the second mode and generates a control signal (not shown) for the switch circuit 109. According to the control signal, the switch circuit 109 alternatively connects the transmitting circuit 107 to the first antenna 102 for transmitting the wireless signals, or connects the receiving circuit 108 to the second antenna 104 for receiving the wireless signals. Note that the user can input the control signal to control the switch circuit 109.

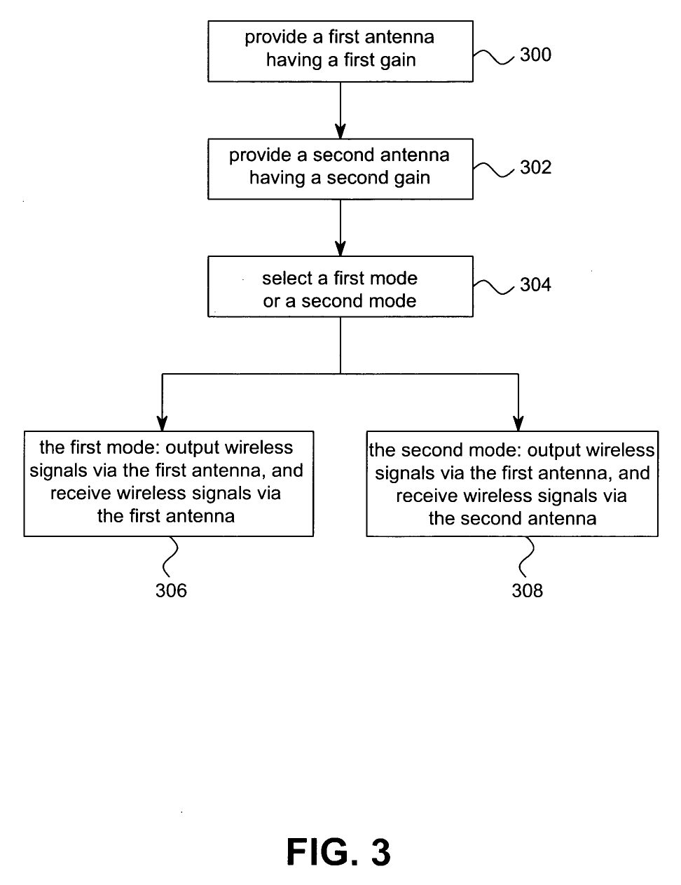

Cooperating with the wireless electronic device 100 of FIG. 1a, FIG. 3 is a flowchart of a method according to an embodiment of the present invention. In the step 300, providing a first antenna having a first gain. The first antenna can be implemented as two identical antennas 102a, 102b shown in FIG. 1a. In the step 302, providing a second antenna having a second gain. Preferably, the second gain is greater than the first gain. In the step 304, selectively performing the first mode or the second mode. Typically, the first mode is the default mode of the wireless electronic device 100. In the step 306 where the first mode is performed, outputting wireless signals via the first antenna 102, and receiving wireless signals via the first antenna 102. However, when the processing circuit 109 is going to receive HDTV signals or the data transmission rate is up to 30 Mbps, the step 308 rather than the step 306 is performed. In the step 308 where the second mode is performed, outputting wireless signals via the first antenna 102, and receiving wireless signals via the second antenna 104.

Further refer to the switch circuit 109 shown in FIG. 2a and FIG. 2b. In an embodiment, in the step 306, the switch circuit 109 alternatively connects the transmitting circuit 107 to the first antenna 102 for transmitting the wireless signals, or connects the receiving circuit 108 to the first antenna 102 for receiving the wireless signals. In another embodiment, in the step 308, the switch circuit 109 alternatively connects the transmitting circuit 107 to the first antenna 102 for transmitting the wireless signals, or connects the receiving circuit 108 to the second antenna 104 for receiving the wireless signals.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A wireless electronic device, comprising:
a first antenna having a first gain;
a second antenna having a second gain; and
a processing circuit alternatively performing a first mode or a second mode;
wherein, when said first mode is performed, said processing circuit outputs wireless signals via said first antenna, and receives wireless signals via said first antenna; and
wherein, when said second mode is performed, said processing circuit outputs wireless signals via said first antenna, and receives wireless signals via said second antenna.

2. A wireless electronic device according to claim 1, wherein, when said second mode is performed, said processing circuit outputs wireless signals via said first antenna, and receives wireless signals further via said first antenna.

3. A wireless electronic device according to claim 1, wherein said second gain is greater than said first gain.

4. A wireless electronic device according to claim 1, wherein said first antenna and said second antenna have the substantially same working frequency.

5. A wireless electronic device according to claim 1, wherein, when said second mode is performed, said processing circuit receives signals of High Definition Digital TV (HDTV) via said second antenna.

6. A wireless electronic device according to claim 1, wherein said first antenna is an omni-directional antenna, and said second antenna is a directional antenna.

7. A wireless electronic device according to claim 1, wherein said processing circuit further comprises:
a transmitting circuit;
a receiving circuit; and
a switch circuit for switching between said first mode and said second mode;
wherein, when said first mode is performed, said switch circuit alternatively connects said transmitting circuit to said first antenna for transmitting said wireless signals, or connects said receiving circuit to said first antenna for receiving said wireless signals; and
wherein, when said second mode is performed, said switch circuit alternatively connects said transmitting circuit to said first antenna for transmitting said wireless signals, or connects said receiving circuit to said second antenna for receiving said wireless signals.

8. An antenna module used in a wireless electronic device for connecting with a wireless network, said wireless electronic device having a first mode and a second mode, said antenna module comprising:
a first antenna having a first gain; and
a second antenna having a second gain;
wherein, when said first mode is performed, said first antenna outputs and receives wireless signals for said wireless electronic device; and
wherein, when said second mode is performed, said first antenna outputs wireless signals for said wireless electronic device, and said second antenna receives wireless signals for said wireless electronic device.

9. An antenna module according to claim 8, wherein, when said second mode is performed, said first antenna outputs wireless signals for said wireless electronic device, and said second antenna together with said first antenna receive wireless signals for said wireless electronic device.

10. An antenna module according to claim 8, wherein said second gain is greater than said first gain.

11. An antenna module according to claim 8, wherein said first antenna and said second antenna have the substantially same working frequency.

12. An antenna module according to claim 8, wherein, when said second mode is performed, said second antenna receives signals of High Definition Digital TV.

13. An antenna module according to claim 8, wherein said first antenna is an omni-directional antenna, and said second antenna is a directional antenna.

14. An antenna module according to claim 8, said wireless electronic device comprising a transmitting circuit and a receiving circuit, and said antenna module comprising a switch circuit for switching between said first mode and said second mode,
wherein, when said first mode is performed, said switch circuit alternatively connects said transmitting circuit to said first antenna for transmitting said wireless signals, or connects said receiving circuit to said first antenna for receiving said wireless signals; and
wherein, when said second mode is performed, said switch circuit alternatively connects said transmitting circuit to said first antenna for transmitting said wireless signals, or connects said receiving circuit to said second antenna for receiving said wireless signals.

15. A method for controlling a wireless electronic device, said wireless electronic device having a first mode and a second mode, said method comprising:
(a) providing a first antenna, said first antenna having a first gain;
(b) providing a second antenna, said second antenna having a second gain;
(c) selectively performing said first mode or said second mode;
(d) when said first mode is performed, outputting wireless signals via said first antenna, and receiving wireless signals via said first antenna; and
(e) when said second mode is performed, outputting wireless signals via said first antenna, and receiving wireless signals via said second antenna.

16. A method according to claim 15, wherein in the step (e):
when said second mode is performed, outputting wireless signals via said first antenna, and receiving wireless signals further via said first antenna.

17. A method according to claim 15, wherein said second gain is greater than said first gain.

18. A method according to claim 15, wherein said first antenna and said second antenna have substantially the same working frequency.

19. A method according to claim 15, wherein, when said second mode is performed, said processing circuit receives signals of High Definition Digital TV via said second antenna.

20. A method according to claim 15, wherein said wireless electronic device comprises a transmitting circuit and a receiving circuit;
wherein in the step (d): when said first mode is performed, alternatively connecting said transmitting circuit to said first antenna for transmitting said wireless signals, or connecting said receiving circuit to said first antenna for receiving said wireless signals; and
wherein in the step (e): when said second mode is performed, alternatively connecting said transmitting circuit to said first antenna for transmitting said wireless signals, or connecting said receiving circuit to said second antenna for receiving said wireless signals.
